(19) United States
(12) Patent Application Publication
(10) Pub. No.: US 2010/0030660 A1
(43) Pub. Date: Feb. 4, 2010

(54) APPARATUS AND METHOD OF ON-LINE TRANSACTION

(75) Inventor: Peter Edwards, London (GB)

Correspondence Address: KATTEN MUCHIN ROSENMAN LLP, 575 MADISON AVENUE, NEW YORK, NY, 10022-2585, US

(73) Assignee: SONY COMPUTER ENTERTAINMENT EUROPE LTD., London (GB)

(21) Appl. No.: 12/185,170

(22) Filed: Aug. 4, 2008

(51) Int. Cl. G06Q 30/00

(52) U.S. Cl. 705/27

(57) ABSTRACT

An entertainment device includes a display generator arranged to generate for display a representation of an online virtual environment, and to generate for display within said representation of the online virtual environment at least one avatars corresponding to users of at least one remote entertainment devices interacting with the online virtual environment. A data communications arrangement is operable to receive respective configuration data for at least one of the avatars that determines their appearance, and is operable to receive data identifying purchasable items visibly associated with a respective avatar; a query arrangement operable to initiate a query of an avatar and to identify to a user of the entertainment device purchasable items visibly associated with the avatar; and in which the data communications arrangement is operable to transmit a purchase initiation request identifying an item for purchase, selected in response to a purchasable item visibly associated with the queried avatar.

### BACKGROUND OF THE INVENTION

1. Field of the Invention

The present invention relates to an apparatus and method of on line transaction.

2. Description of the Prior Art

On-line social environments are a burgeoning field. In addition to text-based systems such as MYSPACE®, virtual worlds have been created for the specific purpose of socialisation, such as SECOND LIFE®. Similarly, there is often a strong social aspect in massively multiplayer on-line games such as WORLD OF WARCRAFT®.

One aspect of a real social environment is commerce, and this aspect of has been replicated extensively in virtual worlds. For example, in WORLD OF WARCRAFT®, individuals wishing to sell items must submit them to an auction house, where visitors can interact with a bidding interface not unlike an in-game version of EBAY®. Meanwhile in SECOND LIFE®, users can create their own shops in which to sell their own creations, and can advertise by use of signs outside their shops.

However, these systems do not provide an equivalent of the word-of-mouth means by which knowledge of available products can spread within a buying public.

It is an object of the present invention to mitigate or alleviate the above problem.

### SUMMARY OF THE INVENTION

The invention provides an entertainment device comprising a display generator arranged to generate for display a representation of an on-line virtual environment, and to generate for display within said representation of the on-line virtual environment one or more avatars corresponding to users of one or more remote entertainment devices interacting with the on-line virtual environment, a data communications arrangement operable to receive respective configuration data for one or more of said avatars that determines their appearance, and operable to receive data identifying purchasable items visibly associated with a respective avatar, a query arrangement operable to initiate a query of an avatar and to identify to a user of the entertainment device purchasable items visibly associated with said avatar, and in which the data communications arrangement is operable to transmit a purchase initiation request identifying an item for purchase, selected in response to a purchasable item visibly associated with said queried avatar.

The invention provides a server arranged to administer an online virtual environment, and comprising a data communications arrangement operable to transmit to an entertainment device connected to the online virtual environment configuration data that determines the appearance of one or more avatars of further entertainment devices connected to said online virtual environment, and operable to transmit data identifying purchasable items visibly associated with a respective avatar.

The invention provides a method of online transaction comprising the steps of connecting an entertainment device to an on-line virtual environment populated by one or more avatars representing other users of the on-line virtual environment, receiving respective configuration data for said one or more avatars that determines their appearance, identifying purchasable items visibly associated with a first avatar, and transmitting to a server a purchase initiation request identifying an item for purchase selected in response to a purchasable item visibly associated with the first avatar.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of an entertainment device;

FIG. 2 is a schematic diagram of a cell processor;

FIG. 3 is a schematic diagram of a video graphics processor;

FIG. 4 is a schematic diagram of an interconnected set of game zones in accordance with an embodiment of the present invention;

FIG. 5 is a schematic diagram of a Home environment online client/server arrangement in accordance with an embodiment of the present invention;

FIG. 6a is a schematic diagram of a lobby zone in accordance with an embodiment of the present invention;

FIG. 6b is a schematic diagram of a lobby zone in accordance with an embodiment of the present invention;

FIG. 6c is a schematic diagram of a cinema zone in accordance with an embodiment of the present invention;

FIG. 6d is a schematic diagram of a developer/publisher zone in accordance with an embodiment of the present invention;

FIG. 7 is a flow diagram of a method of on-line transaction in accordance with an embodiment of the present invention;

FIG. 8a is schematic diagram of an apartment zone in accordance with an embodiment of the present invention;

FIG. 8b is schematic diagram of a trophy room zone in accordance with an embodiment of the present invention;

FIG. 9 is a schematic diagram of a communication menu in accordance with an embodiment of the present invention;

FIG. 10 is a schematic diagram of an interactive virtual user device in accordance with an embodiment of the present invention;

FIG. 11 is a schematic diagram of an avatar in a lobby zone in accordance with an embodiment of the present invention; and

FIG. 12 is a flow diagram of a method of on-line transaction in accordance with an embodiment of the present invention.

### DESCRIPTION OF THE PREFERRED EMBODIMENTS

An apparatus and method of online transaction are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In a summary example embodiment of the present invention, a server hosts an on-line virtual environment to which a plurality of entertainment devices, such as the SONY® PLAYSTATION 3® are connected. The users of each entertainment device are represented within the virtual environment by avatars (human or human-like graphical models). These avatars may be extensively configurable, and draw upon a wide range of default clothes and accessories. However, additional premium clothes and accessories may be provided for purchase either by the administrators of the on-line environment or third parties. Such premium clothes or accessories may, for example, correspond to prestige branded products found in real life. Where a user has purchased such items for their avatar, information identifying the purchasable items is incorporated within their avatar's configuration data, which is normally distributed to each entertainment device in the virtual environment. Thus when a user encounters an avatar with a premium item visibly associated with it, if they like the item they can obtain purchase details for it via that avatar and order it for their own avatar or, if the item corresponds to a real-world item, they can alternatively or in addition order it for themselves.

In this way awareness of purchasable clothes and accessories can be disseminated throughout the virtual population by person-to-person (avatar-to-avatar) encounters, without the need for additional intrusive adverts within the virtual environment, or for a user to actually visit a virtual store.

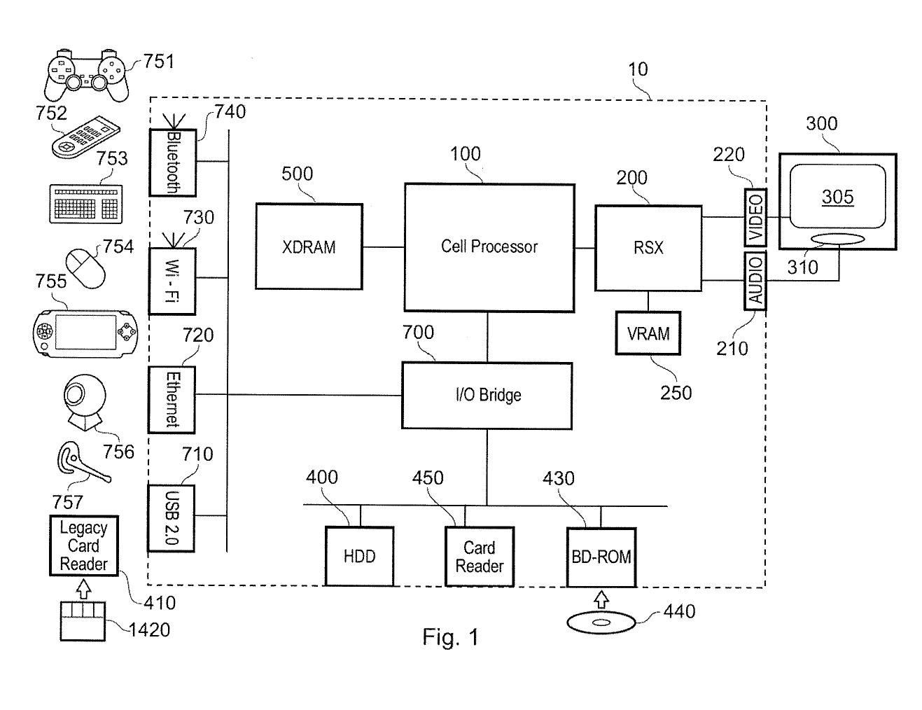

FIG. 1 schematically illustrates the overall system architecture of a SONY®® PLAYSTATION 3® entertainment device. A system unit 10 is provided, with various peripheral devices connectable to the system unit.

The system unit 10 comprises: a Cell processor 100; a RAMBUS® dynamic random access memory (XDRAM) unit 500; a Reality Synthesiser graphics unit 200 with a dedicated video random access memory (VRAM) unit 250; and an I/O bridge 700.

The system unit 10 also comprises a BLU-RAY® Disk BD-ROM® optical disk reader 430 for reading from a disk 440 and a removable slot-in hard disk drive (HDD) 400, accessible through the I/O bridge 700. Optionally the system unit also comprises a memory card reader 450 for reading compact flash memory cards, MEMORY STICK® memory cards and the like, which is similarly accessible through the I/O bridge 700.

The I/O bridge 700 also connects to four Universal Serial Bus (USB) 2.0 ports 710; a gigabit Ethernet port 720; an IEEE 802.11b/g wireless network (Wi-Fi) port 730; and a BLUETOOTH® wireless link port 740 capable of supporting up to seven BLUETOOTH® connections.

In operation the I/O bridge 700 handles all wireless, USB and Ethernet data, including data from one or more game controllers 751. For example when a user is playing a game, the I/O bridge 700 receives data from the game controller 751 via a BLUETOOTH® link and directs it to the Cell processor 100, which updates the current state of the game accordingly.

The wireless, USB and Ethernet ports also provide connectivity for other peripheral devices in addition to game controllers 751, such as: a remote control 752; a keyboard 753; a mouse 754; a portable entertainment device 755 such as a SONY® PLAYSTATION PORTABLE® entertainment device; a video camera such as an EYETOY® video camera 756; and a microphone headset 757. Such peripheral devices may therefore in principle be connected to the system unit 10 wirelessly; for example the portable entertainment device 755 may communicate via a Wi-Fi ad-hoc connection, whilst the microphone headset 757 may communicate via a BLUETOOTH® link.

The provision of these interfaces means that the PLAYSTATION 3® device is also potentially compatible with other peripheral devices such as digital video recorders (DVRs), set-top boxes, digital cameras, portable media players, Voice over IP telephones, mobile telephones, printers and scanners.

In addition, a legacy memory card reader 410 may be connected to the system unit via a USB port 710, enabling the reading of memory cards 420 of the kind used by the PLAYSTATION® or PLAYSTATION 2® devices.

In the present embodiment, the game controller 751 is operable to communicate wirelessly with the system unit 10 via the BLUETOOTH® link. However, the game controller 751 can instead be connected to a USB port, thereby also providing power by which to charge the battery of the game controller 751. In addition to one or more analogue joysticks and conventional control buttons, the game controller is sensitive to motion in 6 degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the PLAYSTATION PORTABLE® device may be used as a controller. In the case of the PLAYSTATION PORTABLE® device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 752 is also operable to communicate wirelessly with the system unit 10 via a BLUETOOTH® link. The remote control 752 comprises controls suitable for the operation of the BLU-RAY®®BLU-RAY®® Disk BD-ROM reader 430 and for the navigation of disk content.

The BLU-RAY® Disk BD-ROM reader 430 is operable to read CD-ROMs compatible with the Playstation and PLAYSTATION 2® devices, in addition to conventional pre-recorded and recordable CDs, and so-called Super Audio CDs. The reader 430 is also operable to read DVD-ROMs compatible with the PLAYSTATION 2® and PLAYSTATION 3® devices, in addition to conventional pre-recorded and recordable DVDs. The reader 430 is further operable to read BD-ROMs compatible with the PLAYSTATION 3® device, as well as conventional pre-recorded and recordable BLU-RAY® Disks.

The system unit 10 is operable to supply audio and video, either generated or decoded by the PLAYSTATION 3® device via the Reality Synthesiser graphics unit 200, through audio and video connectors to a display and sound output device 300 such as a monitor or television set having a display 305 and one or more loudspeakers 310. The audio connectors 210 may include conventional analogue and digital outputs whilst the video connectors 220 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 100. The PLAYSTATION 3® device's operating system supports Dolby® 5.1 surround sound, Dolby® Theatre Surround (DTS), and the decoding of 7.1 surround sound from BLU-RAY® disks.

In the present embodiment, the video camera 756 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 10. The camera LED indicator is arranged to illuminate in response to appropriate control data from the system unit 10, for example to signify adverse lighting conditions. Embodiments of the video camera 756 may variously connect to the system unit 10 via a USB, BLUETOOTH® or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 10, an appropriate piece of software such as a device driver should be provided. Device driver technology is well-known and will not be described in detail here, except to say that the skilled man will be aware that a device driver or similar software interface may be required in the present embodiment described.

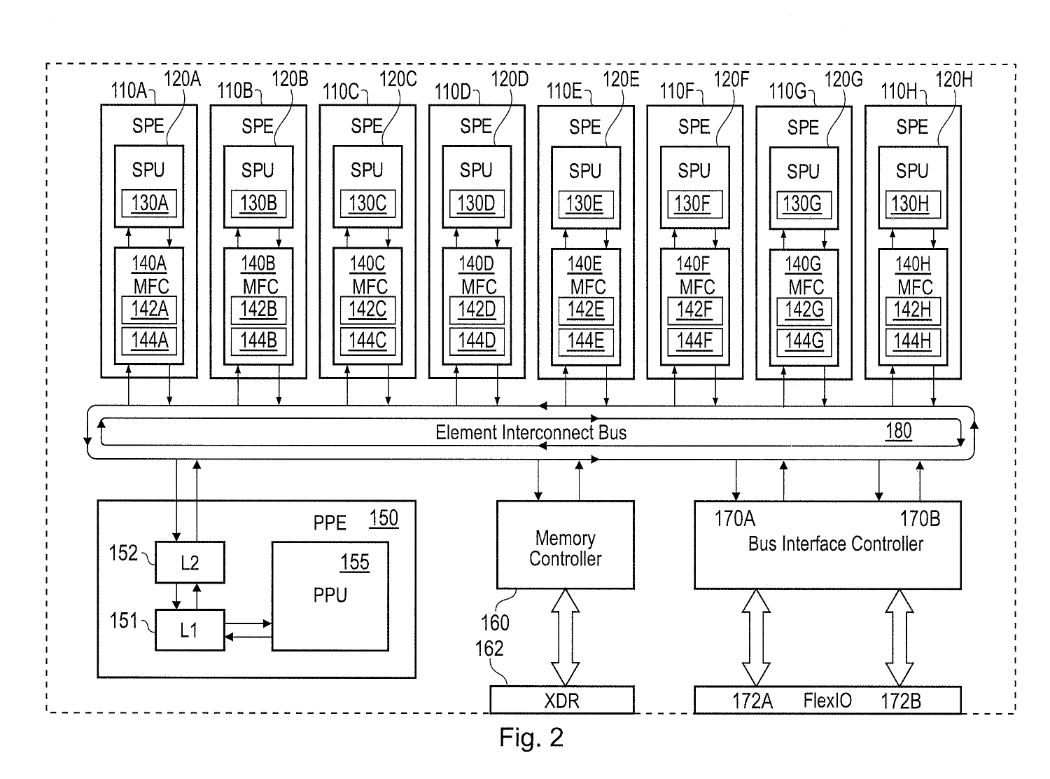

Referring now to FIG. 2, the Cell processor has an architecture comprising four basic components: external input and output structures comprising a memory controller 160 and a dual bus interface controller 170A,B; a main processor referred to as the Power Processing Element 150; eight co-processors referred to as Synergistic Processing Elements (SPEs) 110A-H; and a circular data bus connecting the above components referred to as the Element Interconnect Bus 180. The total floating point performance of the Cell processor is 218 GFLOPS, compared with the 6.2 GFLOPs of the PLAYSTATION 2® device's Emotion Engine.

The Power Processing Element (PPE) 150 is based upon a two-way simultaneous multithreading Power 970 compliant PowerPC core (PPU) 155 running with an internal clock of 3.2 GHz. It comprises a 512 kB level 2 (L2) cache and a 32 kB level 1 (L1) cache. The PPE 150 is capable of eight single position operations per clock cycle, translating to 25.6 GFLOPs at 3.2 GHz. The primary role of the PPE 150 is to act as a controller for the Synergistic Processing Elements 110A-H, which handle most of the computational workload. In operation the PPE 150 maintains a job queue, scheduling jobs for the Synergistic Processing Elements 110A-H and monitoring their progress. Consequently each Synergistic Processing Element 110A-H runs a kernel whose role is to fetch a job, execute it and synchronise with the PPE 150.

Each Synergistic Processing Element (SPE) 110A-H comprises a respective Synergistic Processing Unit (SPU) 120A-H, and a respective Memory Flow Controller (MFC) 140A-H comprising in turn a respective Dynamic Memory Access Controller (DMAC) 142A-H, a respective Memory Management Unit (MMU) 144A-H and a bus interface (not shown). Each SPU 120A-H is a RISC processor clocked at 3.2 GHz and comprising 256 kB local RAM 130A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 120A-H does not directly access the system memory XDRAM 500; the 64-bit addresses formed by the SPU 120A-H are passed to the MFC 140A-H which instructs its DMA controller 142A-H to access memory via the Element Interconnect Bus 180 and the memory controller 160.

The Element Interconnect Bus (EIB) 180 is a logically circular communication bus internal to the Cell processor 100 which connects the above processor elements, namely the PPE 150, the memory controller 160, the dual bus interface 170A,B and the 8 SPEs 110A-H, totalling 12 participants. Participants can simultaneously read and write to the bus at a rate of 8 bytes per clock cycle. As noted previously, each SPE 110A-H comprises a DMAC 142A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96 B per clock, in the event of full utilization through arbitration between participants. This equates to a theoretical peak bandwidth of 307.2 GB/s (gigabytes per second) at a clock rate of 3.2 GHz.

The memory controller 160 comprises an XDRAM interface 162, developed by Rambus Incorporated. The memory controller interfaces with the RAMBUS® XDRAM 500 with a theoretical peak bandwidth of 25.6 GB/s.

The dual bus interface 170A,B comprises a RAMBUS FLEXIO® system interface 172A,B. The interface is organised into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 100 to the Reality Simulator graphics unit 200 will typically comprise display lists, being a sequence of commands to draw vertices, apply textures to polygons, specify lighting conditions, and so on.

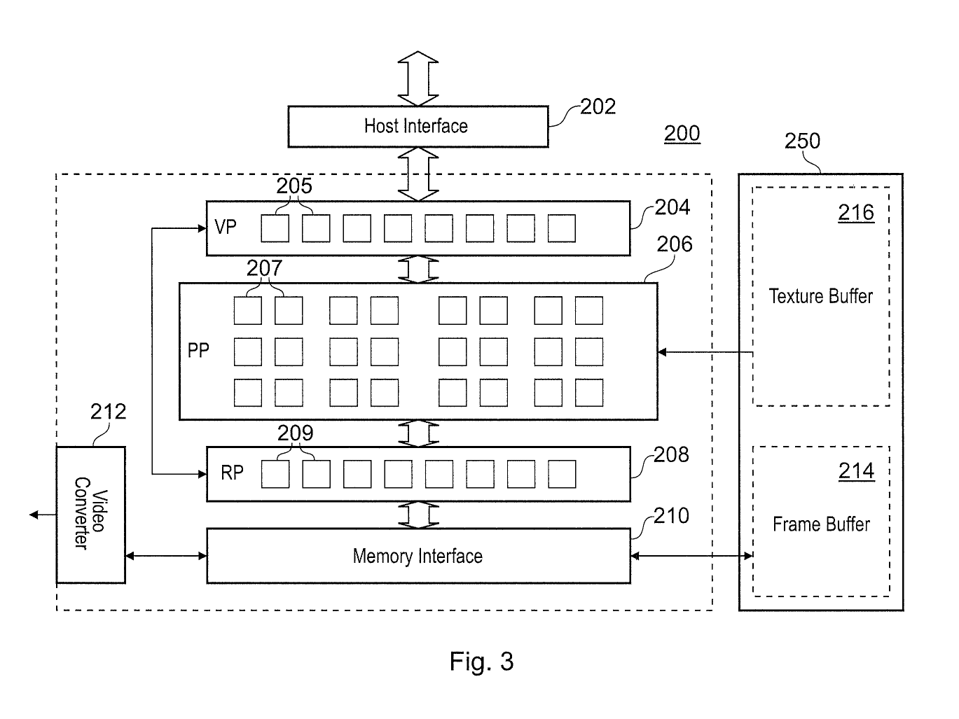

Referring now to FIG. 3, the Reality Simulator graphics (RSX) unit 200 is a video accelerator based upon the NVIDIA® G70/71 architecture that processes and renders lists of commands produced by the Cell processor 100. The RSX unit 200 comprises a host interface 202 operable to communicate with the bus interface controller 170B of the Cell processor 100; a vertex pipeline 204 (VP) comprising eight vertex shaders 205; a pixel pipeline 206 (PP) comprising 24 pixel shaders 207; a render pipeline 208 (RP) comprising eight render output units (ROPs) 209; a memory interface 210; and a video converter 212 for generating a video output. The RSX 200 is complemented by 256 MB double data rate (DDR) video RAM (VRAM) 250, clocked at 600 MHz and operable to interface with the RSX 200 at a theoretical peak bandwidth of 25.6 GB/s. In operation, the VRAM 250 maintains a frame buffer 214 and a texture buffer 216. The texture buffer 216 provides textures to the pixel shaders 207, whilst the frame buffer 214 stores results of the processing pipelines. The RSX can also access the main memory 500 via the EIB 180, for example to load textures into the VRAM 250.

The vertex pipeline 204 primarily processes deformations and transformations of vertices defining polygons within the image to be rendered.

The pixel pipeline 206 primarily processes the application of colour, textures and lighting to these polygons, including any pixel transparency, generating red, green, blue and alpha (transparency) values for each processed pixel. Texture mapping may simply apply a graphic image to a surface, or may include bump-mapping (in which the notional direction of a surface is perturbed in accordance with texture values to create highlights and shade in the lighting model) or displacement mapping (in which the applied texture additionally perturbs vertex positions to generate a deformed surface consistent with the texture).

The render pipeline 208 performs depth comparisons between pixels to determine which should be rendered in the final image. Optionally, if the intervening pixel process will not affect depth values (for example in the absence of transparency or displacement mapping) then the render pipeline and vertex pipeline 204 can communicate depth information between them, thereby enabling the removal of occluded elements prior to pixel processing, and so improving overall rendering efficiency. In addition, the render pipeline 208 also applies subsequent effects such as full-screen anti-aliasing over the resulting image.

Both the vertex shaders 205 and pixel shaders 207 are based on the shader model 3.0 standard. Up to 136 shader operations can be performed per clock cycle, with the combined pipeline therefore capable of 74.8 billion shader operations per second, outputting up to 840 million vertices and 10 billion pixels per second. The total floating point performance of the RSX 200 is 1.8 TFLOPS.

Typically, the RSX 200 operates in close collaboration with the Cell processor 100; for example, when displaying an explosion, or weather effects such as rain or snow, a large number of particles must be tracked, updated and rendered within the scene. In this case, the PPU 155 of the Cell processor may schedule one or more SPEs 110A-H to compute the trajectories of respective batches of particles. Meanwhile, the RSX 200 accesses any texture data (e.g. snowflakes) not currently held in the video RAM 250 from the main system memory 500 via the element interconnect bus 180, the memory controller 160 and a bus interface controller 170B. The or each SPE 110A-H outputs its computed particle properties (typically coordinates and normals, indicating position and attitude) directly to the video RAM 250; the DMA controller 142A-H of the or each SPE 110A-H addresses the video RAM 250 via the bus interface controller 170B. Thus in effect the assigned SPEs become part of the video processing pipeline for the duration of the task.

In general, the PPU 155 can assign tasks in this fashion to six of the eight SPEs available; one SPE is reserved for the operating system, whilst one SPE is effectively disabled. The disabling of one SPE provides a greater level of tolerance during fabrication of the Cell processor, as it allows for one SPE to fail the fabrication process. Alternatively if all eight SPEs are functional, then the eighth SPE provides scope for redundancy in the event of subsequent failure by one of the other SPEs during the life of the Cell processor.

The PPU 155 can assign tasks to SPEs in several ways. For example, SPEs may be chained together to handle each step in a complex operation, such as accessing a DVD, video and audio decoding, and error masking, with each step being assigned to a separate SPE. Alternatively or in addition, two or more SPEs may be assigned to operate on input data in parallel, as in the particle animation example above.

Software instructions implemented by the Cell processor 100 and/or the RSX 200 may be supplied at manufacture and stored on the HDD 400, and/or may be supplied on a data carrier or storage medium such as an optical disk or solid state memory, or via a transmission medium such as a wired or wireless network or internet connection, or via combinations of these.

The software supplied at manufacture comprises system firmware and the PLAYSTATION 3® device's operating system (OS). In operation, the OS provides a user interface enabling a user to select from a variety of functions, including playing a game, listening to music, viewing photographs, or viewing a video. The interface takes the form of a so-called cross media-bar (XMB), with categories of function arranged horizontally. The user navigates by moving through the function icons (representing the functions) horizontally using the game controller 751, remote control 752 or other suitable control device so as to highlight a desired function icon, at which point options pertaining to that function appear as a vertically scrollable list of option icons centered on that function icon, which may be navigated in analogous fashion. However, if a game, audio or movie disk 440 is inserted into the BD-ROM optical disk reader 430, the PLAYSTATION 3® device may select appropriate options automatically (for example, by commencing the game), or may provide relevant options (for example, to select between playing an audio disk or compressing its content to the HDD 400).

In addition, the OS provides an on-line capability, including a web browser, an interface with an on-line store from which additional game content, demonstration games (demos) and other media may be downloaded, and a friends management capability, providing on-line communication with other PLAYSTATION 3® device users nominated by the user of the current device; for example, by text, audio or video depending on the peripheral devices available. The on-line capability also provides for on-line communication, content download and content purchase during play of a suitably configured game, and for updating the firmware and OS of the PLAYSTATION 3® device itself. It will be appreciated that the term “on-line” does not imply the physical presence of wires, as the term can also apply to wireless connections of various types.

In an embodiment of the present invention, the above-mentioned online capability comprises interaction with a virtual environment populated by avatars (graphical representations) of the user of the PS3 system unit 10 and of other PS3 users who are currently online.

The software to enable the virtual interactive environment is typically resident on the HDD 400, and can be upgraded and/or expanded by software that is downloaded, or stored on optical disk 440, or accessed by any other suitable means. Alternatively, the software may reside on a flash memory card 420, optical disk 440 or a central server (not shown).

In an embodiment of the present invention, the virtual interactive environment (hereafter called the ‘Home’ environment) is selected from the cross-media bar. The Home environment then starts in a conventional manner similar to a 3D video game by loading and executing control software, loading 3D models and textures into video memory 250, and rendering scenes depicting the Home environment. Alternatively or in addition, the Home environment can be initiated by other programs, such as a separate game.

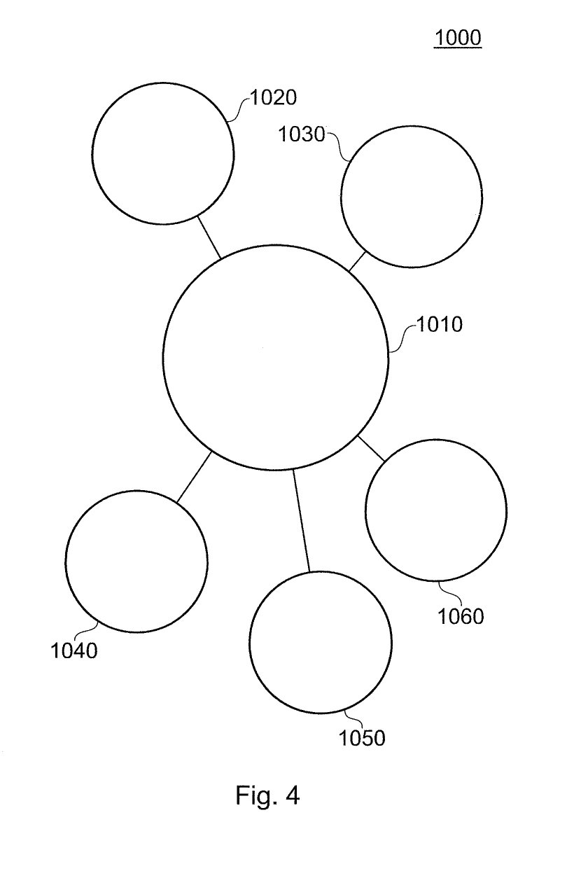

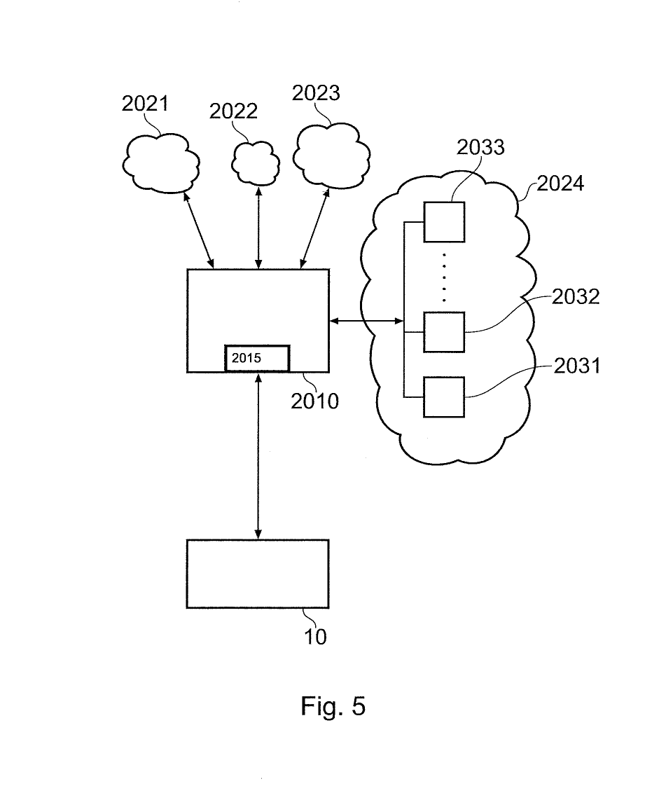

Referring now to FIG. 4, which displays a notional map of the Home environment, and FIG. 5, which is a schematic diagram of a Home environment online client/server arrangement, the user's avatar is spawned within a lobby zone 1010 by default. However, a user can select among other zones 1010-1060 (detailed below) of the map, causing the select zone to be loaded and the avatar to be spawned within that zone. In an embodiment of the present invention, the map screen further comprises a sidebar on which the available zones may be listed, together with management tools such as a ranking option, enabling zones to be listed in order of user preference, or such as most recently added and/or A-Z listings. In addition a search interface may allow the user to search for a zone by name. In an embodiment of the present invention, there maybe many more zones available than are locally stored on the user's PS3 at any one time; the local availability may be colour coded on the list, or the list may be filtered to only display locally available zones. If the user selects a locally unavailable zone, it can be downloaded from a Home environment Server 2010.

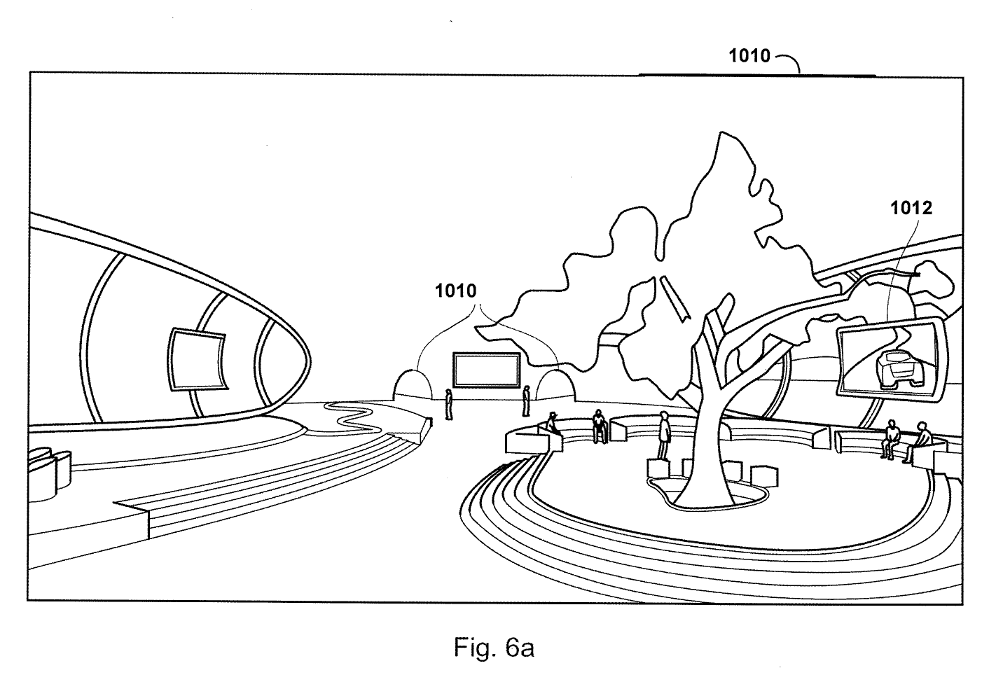

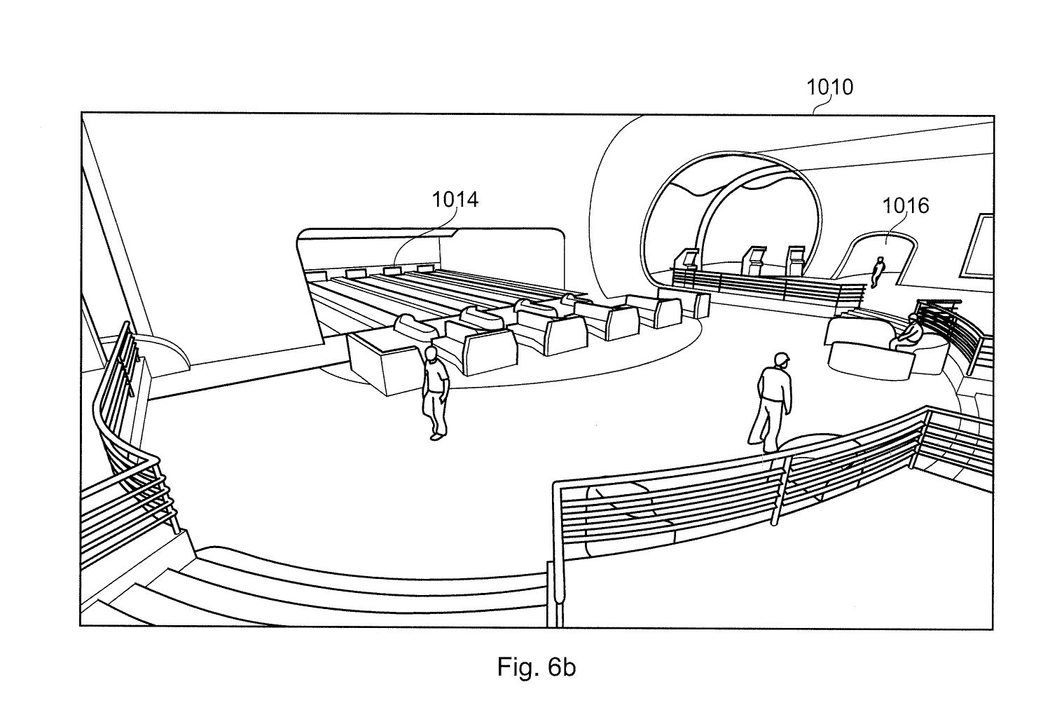

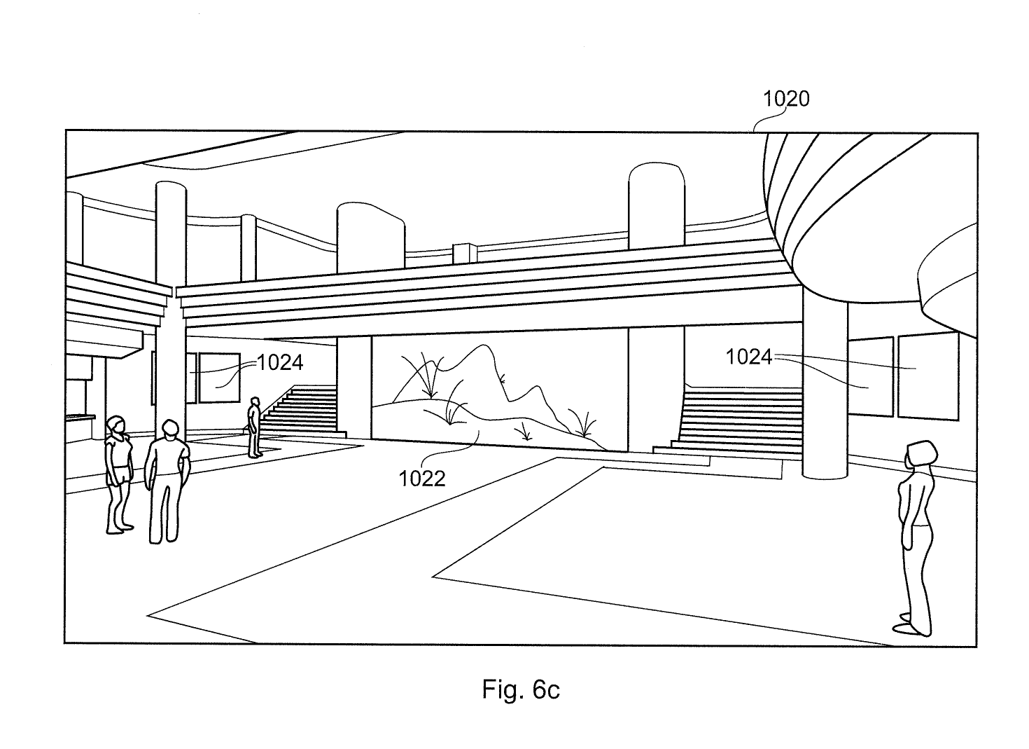

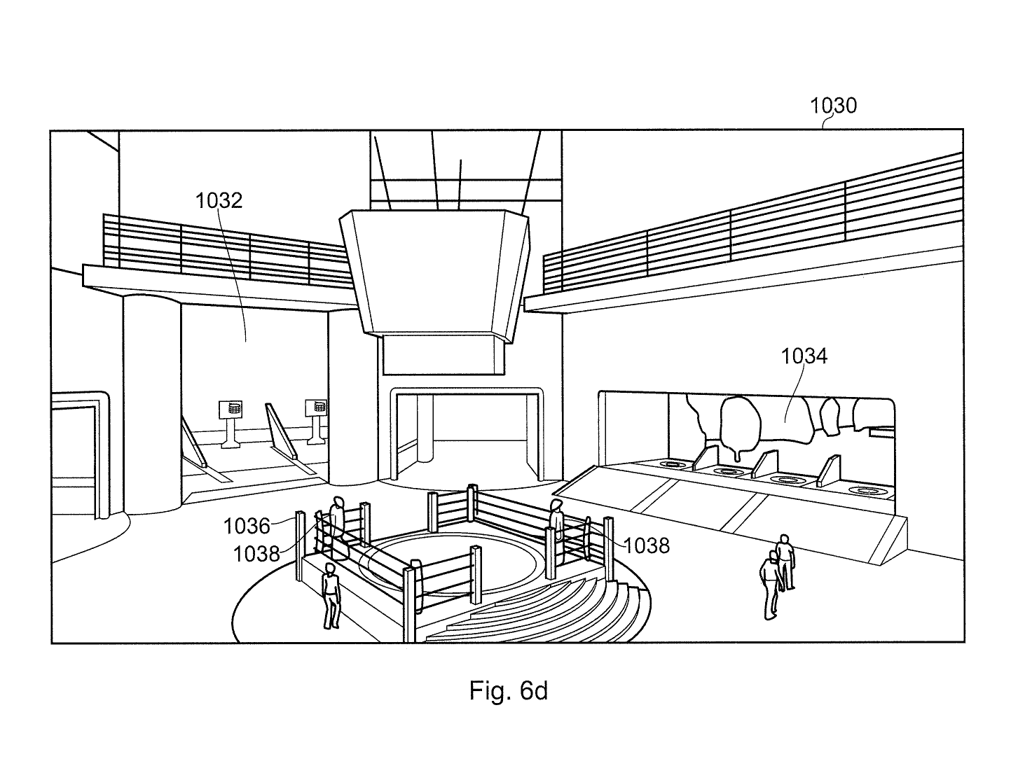

Referring now to FIG. 6a, the lobby zone 1010 typically resembles a covered piazza, and may comprise parkland (grass, trees, sculptures etc.), and gathering spaces (such as open areas, single benches or rows of seats etc.) where users can meet through their avatars.

The lobby zone 1010 typically also comprises advertisement hoardings, for displaying either still or moving adverts for games or other content or products. These may be on the walls of the lobby, or may stand alone.

The lobby zone 1010 may also include an open-air cinema 1012 showing trailers, high-profile adverts or other content from third-party providers. Such content is typically streamed or downloaded from a Home environment server 2010 to which the PS3 10 connects when the Home environment is loaded, as described in more detail later.

The cinema screen is accompanied by seating for avatars in front of it, such that when an avatar sits down, the camera angle perceived by the user of the avatar also encompasses the screen.

Referring now also to FIG. 6b, the lobby zone 1010 may also include general amusements 1014, such as functioning pool tables, bowling alleys, and/or a video arcade. Games of pool or bowling may be conducted via the avatar, such that the avatar holds the pool cue or bowling ball, and is controlled in a conventional manner for such games. In the video arcade, if an avatar approaches a videogame machine, the home environment may switch to a substantially full-screen representation of the videogame selected. Such games may, for example, be classic arcade or console games such as SPACE INVADERS®, or PAC-MAN®, which are comparatively small in terms of memory and processing and can be emulated by the PS3 within the Home environment or run as plug-ins to the Home environment. In this case, typically the user will control the game directly, without representation by the avatar. The game will switch back to the default Home environment view if the user quits the game, or causes the avatar to move away from the videogame machine. In addition to classic arcade games, user-created game content may be featured on one or more of the virtual video game machines. Such content may be the subject of on-line competitions to be featured in such a manner, with new winning content downloaded on a regular basis.

In addition to the lobby zone 1010, other zones (e.g. zones 1020, 1030, 1040, 1050 and 1060, which may be rooms, areas or other constructs) are available. These may be accessed either via a map screen similar in nature to that of FIG. 4, or alternatively the user can walk to these other areas by guiding their avatar to various exits 1016 from the lobby.

Typically, an exit 1016 takes the form of a tunnel or corridor (but may equally take the form of an anteroom) to the next area. While the avatar is within the tunnel or anteroom, the next zone is loaded into memory. Both the lobby and the next zone contain identical models of the tunnel or anteroom, or the model is a common resource to both. In either case, the user's avatar is relocated from the lobby-based version to the new zone-based version of the tunnel or anteroom at the same position. In this way the user's avatar can apparently walk seamlessly throughout the Home environment, without the need to retain the whole environment in memory at the same time.

Referring now also to FIG. 6c, one available zone is a Cinema zone 1020. The Cinema zone 1020 resembles a multiplex cinema, comprising a plurality of screens that may show content such as trailers, movies, TV programs or adverts downloaded or streamed from a Home environment server 2010 as noted previously and detailed below, or may show content stored on the HDD 400 or on an optical disk 440, such as a BLU-RAY® disk.

Typically, the multiplex cinema will have an entrance area featuring a screen 1022 on which high-profile trailers and adverts may be shown to all visitors, together with poster adverts 1024, typically but not limited to featuring upcoming movies. Specific screens and the selection and display of the trailers and posters can each be restricted according to the age of the user, as registered with the PS3. This age restriction can be applied to any displayed content to which an age restriction tag is associated, in any of the zones within the Home environment.

In addition, in an embodiment of the present invention the multiplex cinema provides a number of screen rooms in which featured content is available, and amongst which the user can select. Within a screen room downloaded, streamed or locally stored media can be played within a virtual cinema environment, in which the screen is set in a room with rows of seats, screen curtains, etc. The cinema is potentially available to all users in the Home environment, and so the avatars of other users may also be visible, for example watching commonly streamed material such as a web broadcast. Alternatively, the user can zoom in so that the screen occupies the full viewing area.

Referring now also to FIG. 6d, another type of zone is a developer or publisher zone 1030. Typically, there may be a plurality of such zones available. Optionally, each may have its own exit from the lobby area 1010, or alternatively some or all may share an exit from the lobby and then have separate exits from within a tunnel or ante-room model common to or replicated by each available zone therein. Alternatively they may be selected from a menu, either in the form of a pop-up menu, or from within the Home environment, such as by selecting from a set of signposts. In these latter cases the connecting tunnel or anteroom will appear to link only to the selected developer or publisher zone 1030. Alternatively or in addition, such zones may be selected via the map screen, resulting in the zone being loaded in to memory, and the avatar re-spawning within the selected zone.

Developer or publisher zones 1030 provide additional virtual environments, which may reflect the look and feel of the developer or publisher's products, brands and marks.

The developer or publisher zones 1030 are supplementary software modules to the Home environment and typically comprise additional 3D models and textures to provide the structure and appearance of the zone.

In addition, the software operable to implement the Home environment supports the integration of third party software via an application program interface (API). Therefore, developers can integrate their own functional content within the Home environment of their own zone. This may take the form of any or all of:
i. Downloading/streaming of specific content, such as game trailers or celebrity endorsements;
ii. Changes in avatar appearance, behavior and/or communication options within the zone;
iii. The provision of one or more games, such as basketball 1032 or a golf range 1034, optionally branded or graphically reminiscent of the developer's or publisher's games;
iv. One or more interactive scenes or vignettes representative of the developer's or publisher's games, enabling the player to experience an aspect of the game, hone a specific skill of the game, or familiarize themselves with the controls of a game;
v. An arena, ring, dojo, court or similar area 1036 in which remotely played games may be represented live by avatars 1038, for spectators to watch.

Thus, for example, a developer's zone resembles a concourse in the developer's signature colors and featuring their logos, onto which open gaming areas, such as soccer nets, or a skeet range for shooting. In addition, a booth (not shown) manned by game-specific characters allows the user's avatar to enter and either temporarily change into the lead character of the game, or zoom into a first person perspective, and enter a further room resembling a scene from the featured game. Here the user interacts with other characters from the game, and plays out a key scene. Returning to the concourse, adverts for the game and other content are displayed on the walls. At the end of the zone, the concourse opens up into an arena where a 5-a-side football match is being played, where the positions of the players and the ball correspond to a game currently being played by a popular group, such as a high-ranking game clan, in another country.

In embodiments of the present invention, developer/publisher zones are available to download. Alternatively or in addition, to reduce bandwidth they may be supplied as demo content on magazine disks, or may be installed/upgraded from disk as part of the installation process for a purchased game of the developer or publisher. In the latter two examples, subsequent purchase or registration of the game may result in further zone content being unlocked or downloaded. In any event, further modifications, and timely advert and trailer media, may be downloaded as required.

A similar zone is the commercial zone 1040. Again, there may be a plurality of such commercial zones accessible in similar manner to the developer and publisher zones. Like developer/publisher zones 1030, commercial zones 1040 may comprise representative virtual assets of one or more commercial vendors in the form of 3D models, textures etc., enabling a rendering of their real-world shops, brands and identities, and these may be geographically and/or thematically grouped within zones.

Space within commercial zones may be rented as so-called ‘virtual real-estate’ by third parties. For example, a retailer may pay to have a rendering of their shop included within a commercial zone 1040 as part of a periodic update of the Home environment supplied via the Home environment server 2010, for example on a monthly or annual renewal basis. A retailer may additionally pay for the commerce facilities described above, either on a periodic basis or per item. In this way they can provide users of the Home environment with a commercial presence.

Again, the commercial zone comprises supplementary software that can integrate with the home environment via an API, to provide additional communication options (shop-specific names, goods, transaction options etc), and additional functionality, such as accessing an online database of goods and services for purchase, determining current prices, the availability of goods, and delivery options. Such functions may be accessed either via a menu (either as a pop-up or within the Home environment, for example on a wall) or via communication with automated avatars. Communication between avatars is described in more detail later.

It will be appreciated that developers and publishers can also provide stores within commercial zones, and in addition that connecting tunnels between developer/publisher and commercial zones may be provided. For example, a tunnel may link a developer zone to a store that sells the developer's games. Such a tunnel may be of a ‘many to one’ variety, such that exits from several zones emerge from the same tunnel in-store. In this case, if re-used, typically the tunnel would be arranged to return the user to the previous zone rather than one of the possible others.

In an embodiment of the present invention, the software implementing the Home environment has access to an online-content purchase system provided by the PS3 OS. Developers, publishers and store owners can use this system via an interface to specify the IP address and query text that facilitates their own on-line transaction. Alternatively, the user can allow their PS3 registration details and credit card details to be used directly, such that by selecting a suitably enabled object, game, advert, trailer or movie anywhere within the Home environment, they can select to purchase that item or service. In particular, the Home environment server 2010 can store and optionally validate the user's credit card and other details so that the details are ready to be used in a transaction without the user having to enter them. In this way the Home environment acts as an intermediary in the transaction. Alternatively such details can be stored at the PS3 and validated either by the PS3 or by the Home environment server.

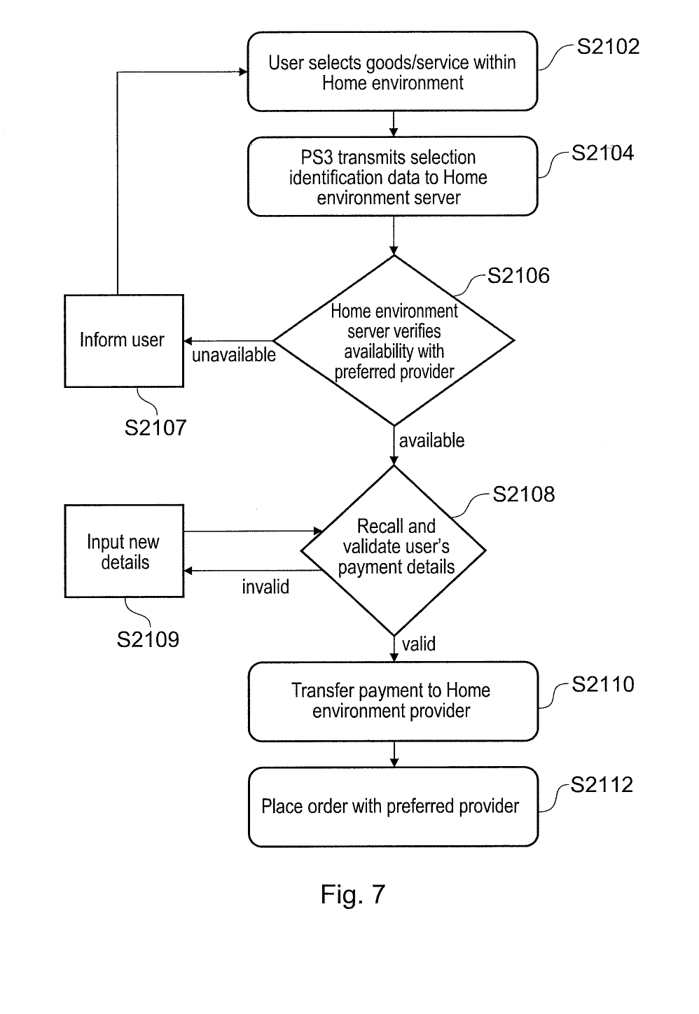

Thus, referring now also to FIG. 7, in an embodiment of the present invention a method of sale comprises in a step s2102 a user selecting an item (goods or a service) within the Home environment. In step s2104, the PS3 10 transmits identification data corresponding with the object to the Home environment server 2010, which in step s2016 verifies the item's availability from a preferred provider (preferably within the country corresponding to the IP address of the user). If the item is unavailable then in step s2107 it informs the user by transmitting a message to the user's PS3 10. Alternatively, it first checks for availability from one or more secondary providers, and optionally confirms whether supply from one of these providers is acceptable to the user. In step s2108, the Home environment server retrieves from data storage the user's registered payment details and validates them. If there is no valid payment method available, then the Home environment may request that the user enters new details via a secure (i.e. encrypted) connection. Once a valid payment method is available, then in step s2110 the Home environment server requests from the appropriate third party payment provider a transfer of payment from the user's account. Finally, in s2112 the Home environment server places an order for the item with the preferred provider, giving the user's delivery address or IP address as applicable, and transferring appropriate payment to the preferred provider's account.

In this way, commerce is not limited specifically to shops. Similarly, it is not necessary for shops to provide their own commerce applications if the preferred provider for goods or services when displayed within a shop is set to be that shop's owner. Where the goods or service may be digitally provided, then optionally it is downloaded from the preferred provider directly or via a Home environment server 2010.

In addition to the above public zones, there are additional zones that are private to the individual user and may only be accessed by them or by invitation from them. These zones also have exits from the communal lobby area, but when entered by the avatar (or chosen via the map screen), load a respective version of the zone that is private to that user.

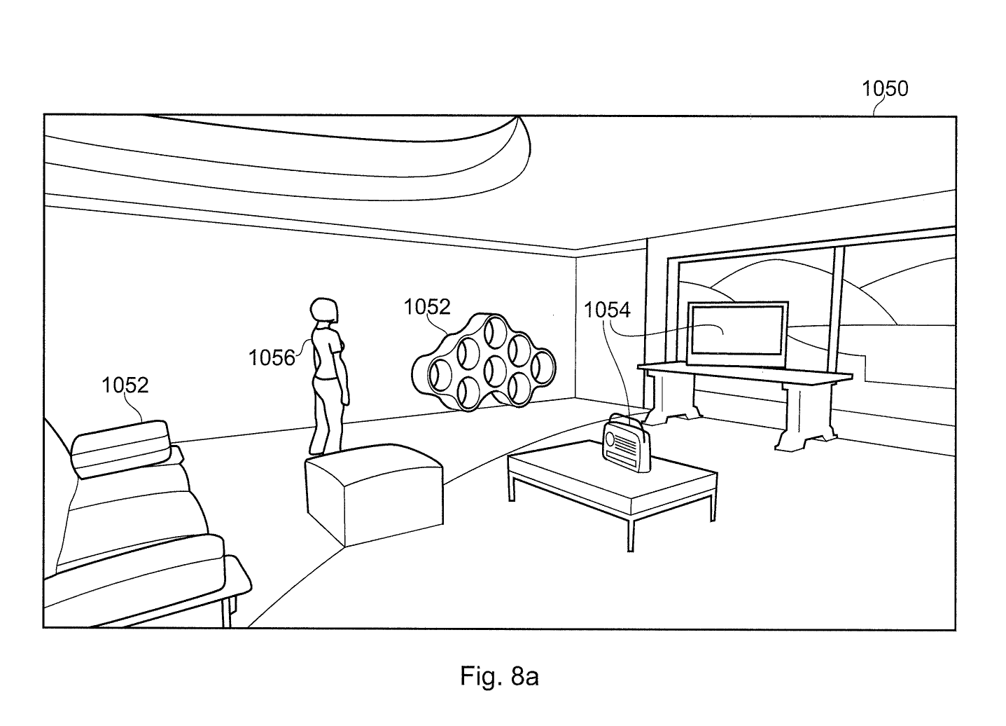

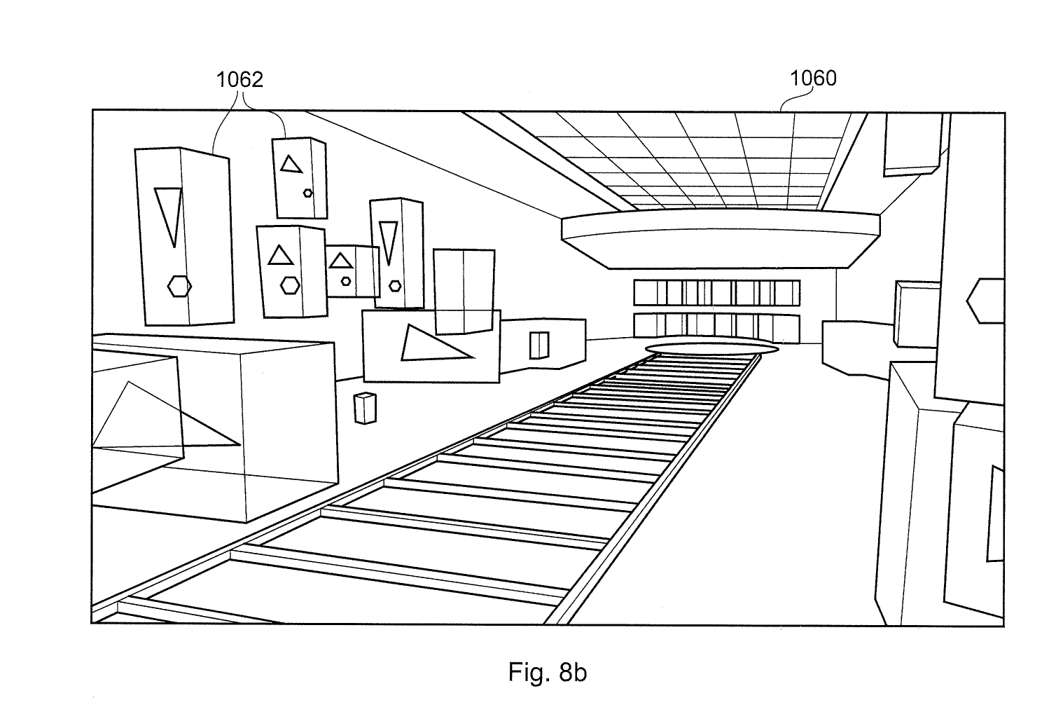

Referring to FIG. 8a, the first of these zones is an apartment zone 1050. In an embodiment of the present invention, this is a user-customizable zone in which such features 1052 as wallpaper, flooring, pictures, furniture, outside scenery and lighting may be selected and positioned. Some of the furniture is functional furniture 1054, linked to PS3 functionality. For example, a television may be placed in the apartment 1050 on which can be viewed one of several streamed video broadcasts, or media stored on the PS3 HDD 400 or optical disk 440. Similarly, a radio or hi-fi may be selected that contains pre-selected links to internet radio streams. In addition, user artwork or photos may be imported into the room in the form of wall hangings and pictures.

Optionally, the user (represented in FIG. 8a by their avatar 1056) may purchase a larger apartment, and/or additional goods such as a larger TV, a pool table, or automated non-player avatars. Other possible items include a gym, swimming pool, or disco area. In these latter cases, additional control software or configuration libraries to provide additional character functionality will integrate with the home environment via the API in a similar fashion to that described for the commercial and developer/publisher zones 1030, 1040 described previously.

Such purchases may be made using credit card details registered with the Home environment server. In return for a payment, the server downloads an authorization key to unlock the relevant item for use within the user's apartment. Alternatively, the 3D model, textures and any software associated with an item may also be downloaded from the Home environment server or an authorized third-party server, optionally again associated with an authorization key. The key may, for example, require correspondence with a firmware digital serial number of the PS3 10, thereby preventing unauthorized distribution.

A user's apartment can only be accessed by others upon invitation from the respective user. This invitation can take the form of a standing invitation for particular friends from within a friends list, or in the form of a single-session pass conferred on another user, and only valid whilst that user remains in the current Home environment session. Such invitations may take the form of an association maintained by a Home environment server 2010, or a digital key supplied between PS3 devices on a peer-to-peer basis that enables confirmation of status as an invitee.

In an embodiment of the present invention invited users can only enter the apartment when the apartment's user is present within the apartment, and are automatically returned to the lobby if the apartment's user leaves. Whilst within the apartment, all communication between the parties present (both user and positional data) is purely peer-to-peer.

The apartment thus also provides a user with the opportunity to share home created content such as artwork, slideshows, audio or video with invited guests, and also to interact with friends without potential interference from other users within the public zones.

When invited guests enter a user's apartment, the configuration of the room and the furnishings within it are transmitted in a peer-to-peer fashion between the attendees using ID codes for each object and positional data. Where a room or item are not held in common between the user and a guest, the model, textures and any code required to implement it on the guest's PS3 may also be transmitted, together with a single-use key or similar constraint, such as use only whilst in the user's apartment and whilst the user and guest remain online in this session.

Referring to FIG. 8b, a further private space that may similarly be accessed only by invitation is the user's Trophy Room 1060. The Trophy Room 1060 provides a space within which trophies 1062 earned during game play may be displayed.

For example, a third-party game comprises seeking a magical crystal. If the player succeeds in finding the crystal, the third party game nominates this as a trophy for the Trophy Room 1060, and places a 3D model and texture representative of the crystal in a file area accessed by the Home environment software when loading the Trophy Room 1060. The software implementing the Home environment can then render the crystal as a trophy within the Trophy Room.

When parties are invited to view a user's trophy room, the models and textures required to temporarily view the trophies are sent from the user's PS3 to those of the other parties on a peer-to-peer basis. This may be done as a background activity following the initial invitation, in anticipation of entering the trophy room, or may occur when parties enter a connecting tunnel/anteroom or select the user's trophy room from the map screen. Optionally, where another party also has that trophy, they will not download the corresponding trophy from the user they are visiting. Therefore, in an embodiment of the present invention, each trophy comprises an identifying code.

Alternatively or in addition, a trophy room may be shared between members of a group or so-called ‘clan’, such that a trophy won by any member of the clan is transmitted to other members of the clan on a peer-to-peer basis. Therefore all members of the clan will see a common set of trophies.

Alternatively or in addition, a user can have a standing invitation to all members of the Home environment, allowing anyone to visit their trophy room. As with the commercial and developer/publisher zones, a plurality of rooms is therefore possible, for example a private, a group-based and a public trophy room. This may be managed either by selection from a pop-up menu or signposts within the Home environment as described previously, or by identifying a relevant user by walking up to their avatar, and then selecting to enter their (public) trophy room upon using the trophy room exit from the lobby.

Alternatively or in addition, a public trophy room may be provided. This room may display the trophies of the person in the current instance of the Home environment who has the most trophies or a best overall score according to a trophy value scoring scheme. Alternatively it may be an aggregate trophy room, showing the best, or a selection of, trophies from some or all of the users in that instance of the Home environment, together with the ID of the user. Thus, for example, a user could spot a trophy from a game they are having difficulty with, identify who in the Home environment won it, and then go and talk to them about how they won it. Alternatively, a public trophy room could contain the best trophies across a plurality of Home environments, identifying the best gamers within a geographical, age specific or game specific group, or even worldwide. Alternatively or in addition, a leader board of the best scoring gamers can be provided and updated live.

It will be appreciated that potentially a large number of additional third party zones may become available, each comprising additional 3D models, textures and control software. As a result a significant amount of space on HDD 400 may become occupied by Home environment zones.

Consequently, in an embodiment of the present invention the number of third party zones currently associated with a user's Home environment can be limited. In a first instance, a maximum memory allocation can be used to prevent additional third party zones being added until an existing one is deleted. Alternatively or in addition, third party zones may be limited according to geographical relevance or user interests (declared on registration or subsequently via an interface with the Home environment server 2010), such that only third party zones relevant to the user by these criteria are downloaded. Under such a system, if a new third party zone becomes available, its relevance to the user is evaluated according to the above criteria, and if it is more relevant than at least one of those currently stored, it replaces the currently least relevant third party zone stored on the user's PS3.

Other criteria for relevance may include interests or installed zones of nominated friends, or the relevance of zones to games or other media that have been played on the user's PS3.

Further zones may be admitted according to whether the user explicitly installs them, either by download or by disk.

As noted above, within the Home environment users are represented by avatars. The software implementing the Home environment enables the customization of a user's avatar from a selection of pre-set options in a similar manner to the customization of the user's apartment. The user may select gender and skin tone, and customize the facial features and hair by combining available options for each. The user may also select from a wide range of clothing. To support this facility, a wide range of 3D models and textures for avatars are provided. In an embodiment of the present invention, user may import their own textures to display on their clothing. Typically, the parameters defining the appearance of each avatar only occupy around 40 bytes, enabling fast distribution via the home server when joining a populated Home environment.

Each avatar in the home environment can be identified by the user's ID or nickname, displayed in a bubble above the avatar. To limit the proliferation of bubbles, these fade into view when the avatar is close enough that the text it contains could easily be read, or alternatively when the avatar is close enough to interact with and/or is close to the centre of the user's viewpoint.

The avatar is controlled by the user in a conventional third-person gaming manner (e.g. using the game controller 751), allowing them to walk around the Home environment. Some avatar behavior is contextual; thus for example the option to sit down will only be available when the avatar is close to a seat. Other avatar behavior is available at all times, such as for example the expression of a selected emotion or gesture, or certain communication options. Avatar actions are determined by use of the game controller 751, either directly for actions such as movement, or by the selection of actions via a pop-up menu, summoned by pressing an appropriate key on the game controller 751.

Options available via such a menu include further modification of the avatar's appearance and clothing, and the selection of emotions, gestures and movements. For example, the user can select that their avatar smiles, waves and jumps up and down when the user sees someone they know in the Home environment.

Users can also communicate with each other via their avatars using text or speech.

To communicate by text, in an embodiment of the present invention, messages appear in pop-up bubbles above the relevant avatar, replacing their name bubble if necessary.

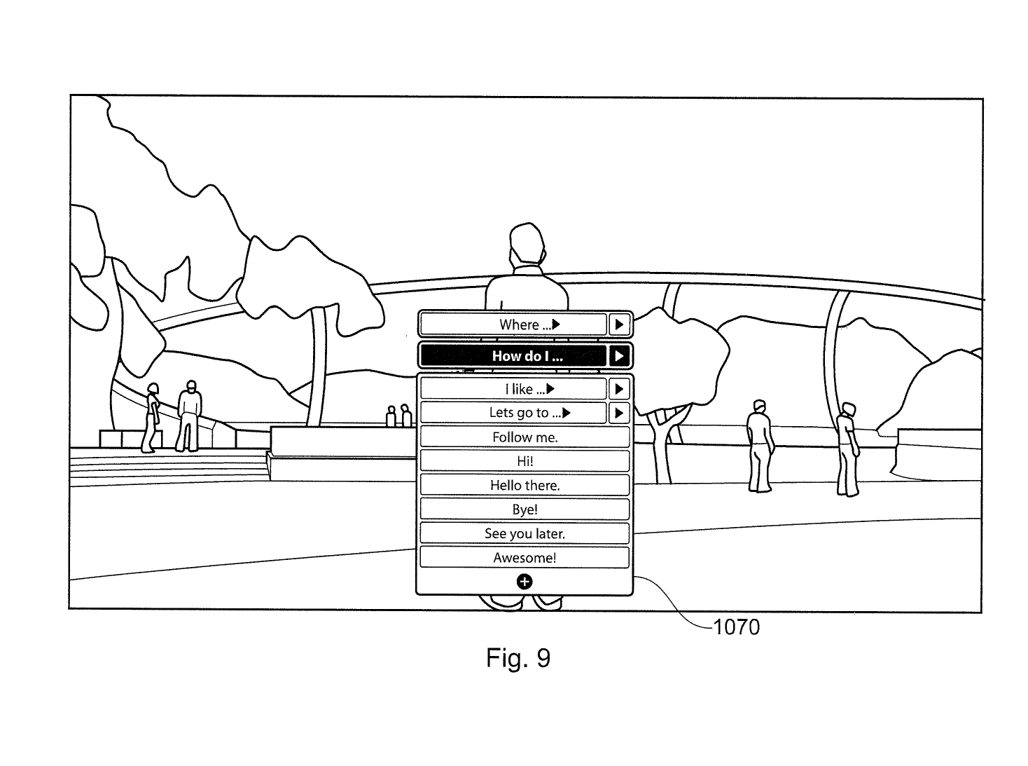

Referring now also to FIG. 9, to generate a message the user can activate a pop-up menu 1070 in which a range of preset messages is provided. These may be complete messages, or alternatively or in addition may take the form of nested menus, the navigation of which generates a message by concatenating selected options.

Alternatively or in addition, a virtual keyboard may be displayed, allowing free generation of text by navigation with the game controller 751. If a real keyboard 753 is connected via BLUETOOTH®, then text may by typed into a bubble directly.

In an embodiment of the present invention, the lobby also provides a chat channel hosted by the Home environment server, enabling conventional chat facilities.

To communicate by speech, a user must have a microphone, such as a BLUETOOTH® headset 757, available. Then in an embodiment of the present invention, either by selection of a speech option by pressing a button on the game controller 751, or by use of a voice activity detector within the software implementing the Home environment, the user can speak within the Home environment. When speaking, a speech icon may appear above the head of the avatar for example to alert other users to adjust volume settings if necessary.

The speech is sampled by the user's PS3, encoded using a Code Excited Linear Prediction (CELP) codec (or other known VoIP applicable codec), and transmitted in a peer-to-peer fashion to the eight nearest avatars (optionally provided they are within a preset area within the virtual environment surrounding the user's avatar). Where more than eight other avatars are within the preset area, one or more of the PS3s that received the speech may forward it to other PS3s having respective user avatars within the area that did not receive the speech, in an ad-hoc manner. To co-ordinate this function, in an embodiment of the present invention the PS3 will transmit a speech flag to all PS3s whose avatars are within the preset area, enabling them to place a speech icon above the relevant (speaking) avatars head (enabling their user to identify the speaker more easily) and also to notify the PS3s of a transmission. Each PS3 can determine from the relative positions of the avatars which ones will not receive the speech, and can elect to forward the speech to the PS3 of whichever avatar they are closest to within the virtual environment. Alternatively, the PS3s within the area can ping each other, and whichever PS3 has the lowest lag with a PS3 that has not received the speech can elect to forward it.

It will be appreciated that the limitation to eight is exemplary, and the actual number depends upon such factors as the speech compression ratio and the available bandwidth.

In an embodiment of the present invention, such speech can also be relayed to other networks, such as a mobile telephony network, upon specification of a mobile phone number. This may be achieved either by routing the speech via the Home environment server to a gateway server of the mobile network, or by BLUETOOTH® transmission to the user's own mobile phone. In this latter case, the mobile phone may require middleware (e.g. a JAVA® (D applet) to interface with the PS3 and route the call.

Thus a user can contact a person on their phone from within the Home environment. In a similar manner, the user can also send a text message to a person on their mobile phone.

In a similar manner to speech, in an embodiment of the present invention users whose PS3s are equipped with a video camera such as the SONY® Eye Toy ® video camera can use a video chat mode, for example via a pop-up screen, or via a TV or similar device within the Home environment, such as a SONY® PLAYSTATION PORTABLE® (PSP) held by the avatar. In this case video codecs are used in addition to or instead of the audio codecs.

Optionally, the avatars of users with whom you have spoken recently can be highlighted, and those with whom you have spoken most may be highlighted more prominently, for example by an icon next to their name, or a level of glow around their avatar.

Referring back to FIG. 5, when a user selects to activate the Home environment on their PS3 10, the locally stored software generates the graphical representation of the Home environment, and connects to a Home environment server 2010 that assigns the user to one of a plurality of online Home environments 2021, 2022, 2023, 2024. Only four home environments are shown for clarity.

It will be understood that potentially many tens of thousands of users may be online at any one time. Consequently to prevent overcrowding, the Home environment server 2010 will support a large plurality of separate instances of online Home environments. Likewise, there may be many separate Home environment servers, for example in different countries.

Once assigned to a Home environment, a PS3 initially uploads information regarding the appearance of the avatar, and then in an ongoing fashion provides the Home environment server with positional data for its own avatar, and receives from the Home environment server the positional data of the other avatars within that online Home environment. In practice this positional update is periodic (for example every 2 seconds) to limit bandwidth, so other PS3s must interpolate movement. Such interpolation of character movement is well-known in on-line games. In addition, each update can provide a series of positions, improving the replication of movement (with some lag), or improving the extrapolation of current movement.

In addition the IP addresses of the other PS3s 2031, 2032, 2033 within that Home environment 2024 is shared so that they can transmit other data such as speech in a peer-to-peer fashion between themselves, thereby reducing the required bandwidth of data handled by the Home environment server.

To prevent overcrowding within the Home environments, each will support a maximum of, for example, 64 users.

The selection of a Home environment to which a user will be connected can take account of a number of factors, either supplied by the PS3 and/or known to the Home environment server via a registration process. These include but are not limited to:
i. The geographical location of the PS3;
ii. The user's preferred language;
iii. The user's age;
iv. Whether any users within the current user's ‘friends list’ are in a particular Home environment already;
v. What game disk is currently within the user's PS3;
vi. What games have recently been played on the user's PS3.

Thus, for example, a Swiss teenager may be connected to a Home environment on a Swiss server, with a maximum user age of 16 and a predominant language of French. In another example, a user with a copy of ‘Revolution’ mounted in their PS3 may be connected to a home environment where a predominant number of other users also currently have the same game mounted, thereby facilitating the organisation of multiplayer games. In this latter case, the PS3 10 detects the game loaded within the BD-ROM 430 and informs the Home environment server 2010. The server then chooses a Home environment accordingly.

In a further example, a user is connected to a Home environment in which three users identified on his friends list can be found. In this latter example, the friends list is a list of user names and optionally IP addresses that have been received from other users that the user given wishes to meet regularly. Where different groups of friends are located on different Home environment servers (e.g. where the current user is the only friend common to both sets) then the user may either be connected to the one with the most friends, or given the option to choose.

Conversely, a user may invite one or more friends to switch between Home environments and join them. In this case, the user can view their friends list via a pop-up menu or from within the Home environment (for example via a screen on the wall or an information booth) and determine who is on-line. The user may then broadcast an invite to their friends, either using a peer-to-peer connection or, if the friend is within a Home environment or the IP address is unknown, via the Home environment server. The friend can then accept or decline the invitation to join.

To facilitate invitation, generally a Home environment server will assign less than the maximum supported number of users to a specific home environment, thereby allowing such additional user-initiated assignments to occur. This so-called ‘soft-limit’ may, for example, be 90% of capacity, and may be adaptive, for example changing in the early evening or at weekends where people are more likely to meet up with friends on-line.

Where several friends are within the same Home environment, in an embodiment of the present invention the map screen may also highlight those zones in which the friends can currently be found, either by displaying their name on the map or in association with the zone name on the side bar.

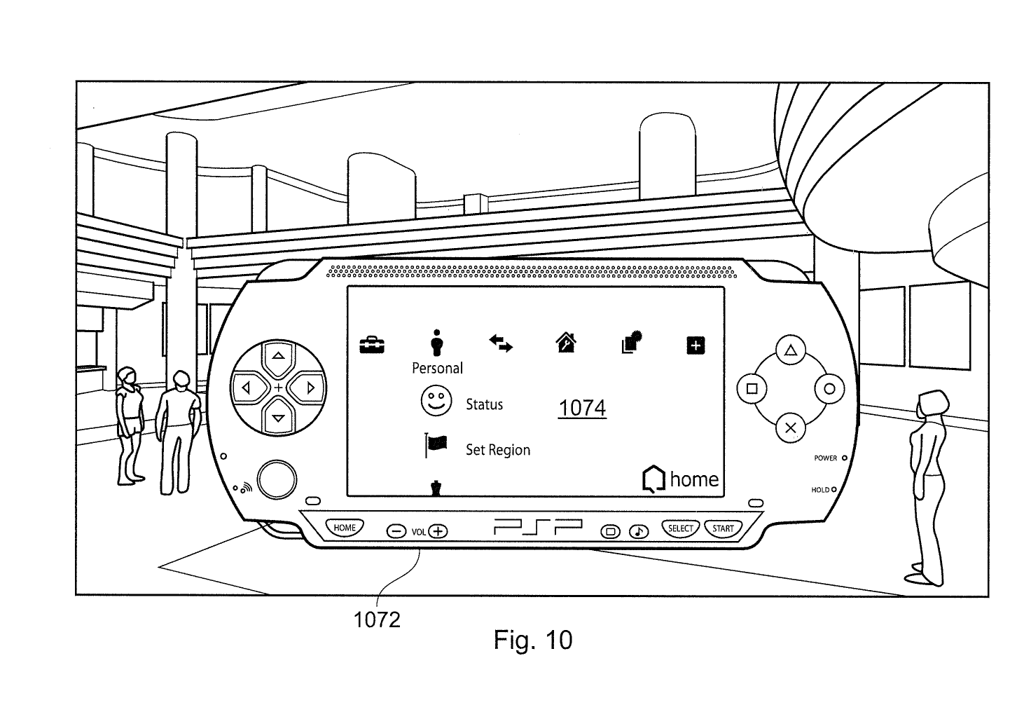

Referring now also to FIG. 10, in addition, preferences, settings, functions of the Home environment and optionally other functionality may be viewed, adjusted or accessed as appropriate by use of a virtual SONY® PLAYSTATION PORTABLE® (PSP) entertainment device 1072 that can be summoned by use of the game controller 751 to pop-up on screen. The user can then access these options, settings and functionality via a PSP cross-media bar 1074 displayed on the virtual PSP. As noted above, the PSP could also be used as an interface for video chat.

When a user wishes to leave the Home environment, in embodiments of the present invention they may do so by selection of an appropriate key on the game controller 751, by selection of an exit option from a pop-up menu, by selection of an exit from within the map screen, by selection of an option via their virtual PSP or by walking through a master exit within the lobby zone.

Typically, exiting the Home environment will cause the PS3 10 to return to the PS3 cross media bar.

Finally, it will be appreciated that additional, separate environments based upon the Home environment software and separately accessible from the PS3 cross-media bar are envisaged. For example, a supermarket may provide a free disk upon which a Supermarket environment, supported in similar fashion by the Home environment servers, is provided. Upon selection, the user's avatar can browse displayed goods within a virtual rendition of the supermarket (either as 3D models or textures applied to shelves) and click on them to purchase as described above. In this way retailers can provide and update online shopping facilities for their own user base.

As noted above, a PS3 10 is operable to display an instance of the ‘Home’ environment (or other environments as provided) which will in general be populated with the avatars of other users as well as the avatar of the user of the PS3 10 (hereafter the ‘local user’). If the virtual environment supports a third-person viewpoint, then the avatar of the local user of the PS3 10 will also be visible.

Also as noted above, each user has the facility to customize their avatar's appearance. This can include selecting among a default range of clothes, shoes, hats and the like.

This customization of a user's avatar may be extended to a range of purchasable items not available by default. Such items may include clothes with designer labels and other accessories such as glasses, jewellery and bags. In addition functional accessories such as cameras and watches or interactive toys such as Frisbees, whose ownership unlocks additional functionality within the on-line environment, may be available for purchase. Such purchases may be achieved for example via the sales method described previously or via redirection to the administrators website, such as the SONY® PLAYSTATION® Store online, or similarly a partnership website.

The new graphical and functional elements of such customized avatars can then be distributed to other PS3s in an instance of the Home environment, for example as described in co-pending application EP 2007253928.1 and incorporated herein by reference, so that these modifications can be rendered for other respective users, enabling them to see the customized avatars. Typically the Home environment server communicates with the local user's PS3 10 via a data communications arrangement 2015.

Alternatively these purchasable elements may be commonly distributed as an existing part of the Home environment software (or an upgrade thereto), in which case the configuration of such avatars for rendering by the PS3s of other users is simply by use of descriptive parameters, as disclosed previously.

In practice, a combination of the two is likely where items for sale are made available by both the owners of the on-line environment and by third parties. Where new graphics and functions are distributed within an instance of the Home environment, these additional resources can be kept by the recipient PS3s for future use in rendering similar avatars, thereby acting as ad-hoc upgrades.

In an embodiment of the present invention, the configuration data for an avatar also includes identifying data indicating those items visibly associated with an avatar that are purchasable by the users of other avatars. Alternatively, the configuration data provides a reference to the identifying data if it is distributed separately by the Home environment server (or a third party server, not illustrated).

Such identifying data comprises an identification code for a purchasable item that is recognizable by the Home environment server 2010, or alternatively or in addition recognizable by a separate sales server (not illustrated). Alternatively the identification code could be part of a URL linking to a partnership website.

This identification code enables the retrieval of further information, including for example the name of the item, a maker's logo or mark, a brief description of the item, the colors available, and/or its price.

Alternatively, such information may be part of the identifying data itself.

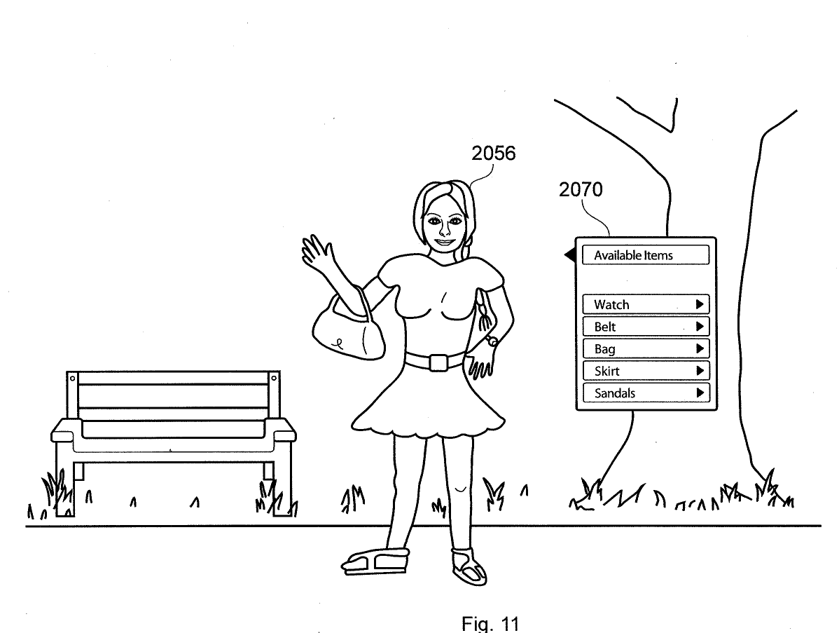

Referring now to FIG. 11, a user of a remote PS3 whose avatar 2056 has been customized in the above manner has joined an instance of the Home environment, and their avatar 2056 has appeared in the parkland area of the lobby 1010.

The local user of the PS3 10, encountering this avatar, may initiate a query of this avatar, either by pressing a dedicated (or context sensitive) button on the controller 751, or as an option within an interaction dialog box such as the interaction dialog box 1070 seen in FIG. 9, or via controls of the virtual console 1072. Alternatively the query may be automatic upon any interaction by the user with the avatar, or when the avatar comes within a threshold virtual distance of the user's viewpoint.

The PS3 either accesses the identifying data already distributed as part of the configuration data of the avatar, or requests it from the Home environment server upon the initiation of such a query.

Using the identifying data, the PS3 generates a dialog box 2070 listing the items associated with the avatar that the local user of the PS3 may purchase themselves. This dialog box may be separate or its contents may be part of a broader range of options, either appended to those options or accessible by the selection of such an option.

In the illustrated example of FIG. 11, the avatar has a selection of clothes and accessories that may be purchased by the local user of the PS3 for their own avatar if desired.

In a non-limiting example, the local user may select to buy the bag. Selecting the bag from the dialog box 2070 initiates the transmission of a purchase initiation request to the Home environment server or alternatively to a separate sales server. Optionally a dialog box requesting confirmation of the local user's choice may be provided between selecting the item and transmitting the request.

The purchase initiation request identifies the selected product using the identification code, and also identifies the local user, either by user ID, network ID, PS3 ID, Home environment login details or similar, or a combination of some or all of the above. This in turn also enables identification of the local user's avatar.

The Home environment server or separate sales server can then request payment details. Such details may be supplied via dialog boxes within the Home environment, or may already be stored on the PS3 and be supplied by it or likewise may already be held by the server or a further, partner server (not illustrated). Once a valid payment method has been identified, payment can be taken in a conventional manner. The confirmation dialog box referred to above may double as a payment authorization or a further confirmation may be requested.

Upon payment, the local user's avatar is reconfigured to reflect the purchase. Such reconfiguration can be achieved at the Home environment server if user avatar configuration settings are stored centrally, or may be achieved by use of a digitally signed authorization sent from the Home environment server or separate sales server to the local user's PS3 to update the user's avatar appropriately if the configuration settings are stored locally. At the same time, any graphics or functionality required to display or utilize the purchased item can be either transmitted to the PS3 or unlocked within the software resident on the PS3 for use in the virtual environment.

In a variant embodiment of the present invention, the local user does not purchase their own additional copy of the item seen on the other avatar but in effect buys it from the owner of the other avatar 2056. In this case, the owner of the other avatar is asked if they wish to sell the relevant item. If they consent, then a payment is credited to them in a known manner, and in addition to the reconfiguration of the local user's avatar to incorporate the purchased item as described above, the seller's avatar is similarly reconfigured to remove it. In the case of clothes, a default replacement could be provided.

This variant, when coupled, for example, with the ability to customize clothes with a user's own textures, and/or to customize 3D meshes (for example within certain size boundaries suitable to the item class), enables the introduction and sale of user—sourced clothing and accessories via such interpersonal encounters.

Furthermore, in an embodiment of the present invention, purchases are not limited to the virtual environment and the local user's avatar. Custom clothing and accessories, either purchased for an avatar or supplied in a promotion, may represent a real-world item. Continuing the above non-limiting example, the avatar 2056 may be wearing a particular style and pattern of skirt that the local user of the PS3 would like to wear themselves. In this case, the dialog box 2070 may indicate that the skirt is available for purchase either for the local user's avatar or for themselves. This may be achieved by listing the skirt twice under different categories, or by use of a color code signifying different types of availability. In the event that the skirt is part of a promotion and only available to certain authorized avatars, it is possible that it would only be available for purchase as a real-world item.

Where it is possible to purchase the real-world version of an item, the identifying information may also link to or comprise a photo or video relating to the real-world item, enabling a more detailed inspection by the local user.

If the local user chooses to buy the skirt for themselves, they may be prompted to provide information relevant to clothing size such as waist, bust or leg dimensions. Alternatively these may already be stored on the PS3 or server and provided or accessed automatically. Likewise the local user may be prompted to provide a delivery address or asked to confirm if it is the same as the billing address. Again alternatively these details may already be stored on the PS3 or server and provided or accessed automatically.

Given these details, the Home environment server or third party server determines the availability and price of the clothing or accessory item, both in terms of the local user's requirements for size, color, etc., and in terms of the local user's geographical location. This information may be obtained either from an internally held database or by communication with a server of a further business partner responsible for supply of the relevant product to the relevant area.

For some items, a geographically local provider that can fulfil the local user's requirements may not be available. In such circumstances, additional shipping fees and delivery time estimates may be provided for one or more alternative providers.

The local user may then indicate their intent to continue with the purchase, either by completing payment details or by explicitly selecting a proceed-with-purchase option provided on-screen. The Home environment server (or third party server) then places the order with the relevant supplier. The local user's payment may be made directly to the supplier, with the supplier paying a proportion back to the owners of the Home environment server (or paying a fixed subscription fee, or a combination of the above), or alternatively the local user's payment may be made to the administrators of the Home Environment server, who then make appropriate payment to the supplier themselves via their respective servers.

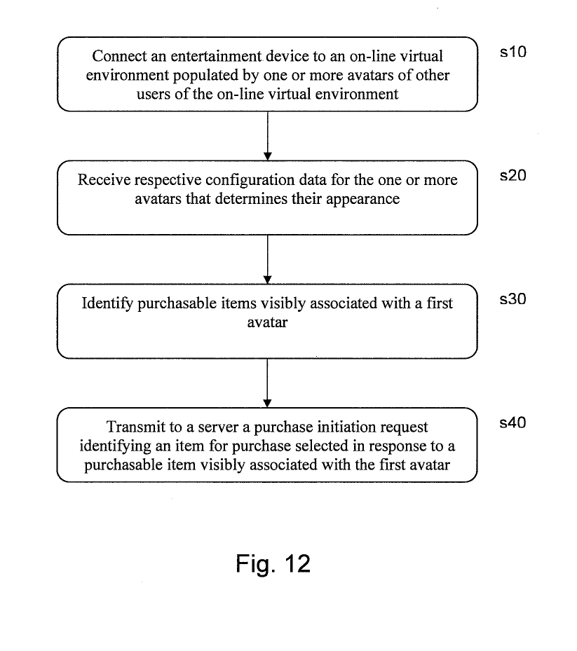

Referring now to FIG. 12, a corresponding method of online transaction comprises:
in a first step, connecting an entertainment device to an on-line virtual environment populated by one or more avatars representing other users of the on-line virtual environment;
in a second step, receiving respective configuration data for the one or more avatars that determines their appearance;
in a third step, identifying purchasable items visibly associated with the avatar; and
in a fourth step, transmitting to a server a purchase initiation request identifying an item for purchase selected in response to a purchasable item visibly associated with the queried avatar.

It will be apparent to a person skilled in the art that variations in the above method corresponding to operation of the various embodiments of the apparatus described above are considered within the scope of the present invention, including but not limited to:
purchasing real-world clothing or accessories in addition to virtual items based upon items visibly associated with a user avatar in a virtual environment;
distributing identification data with the configuration data of an avatar;
distributing identification data to a local user's PS3 when they make an appropriate enquiry of an avatar;
the identification data including one or more ID codes recognized by a server as corresponding to one or more items visibly associated with the avatar that are available for purchase, or a LRL to an online store that serves a similar purpose;
displaying information related to such items, such as for example price, availability, sizes, colors, photos, logos and branding;
reconfiguring a local user's avatar to reflect a purchase;
reconfiguring a seller's avatar to reflect a sale; and
obtaining personal information from a user sufficient to enact the purchase and delivery of a real-world item.

It will be appreciated that in embodiments of the present invention, the method of online transaction and elements of the corresponding enabling apparatus may be implemented in any suitable manner with a suitably adapted entertainment device or server as applicable.

The required adaptation to existing parts of a conventional equivalent device may be implemented in the form of a computer program product comprising processor implementable instructions stored on a data carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realized in hardware as an ASIC (application specific integrated circuit) or an FPGA (field programmable gate array) or other configurable circuit suitable to use in adapting the conventional equivalent device.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An entertainment device comprising:
a display device arranged to generate for display a representation of an online virtual environment, and to generate for display within said representation of the online virtual environment at least one avatar corresponding to users of at least one remote entertainment device interacting with the online virtual environment;
a data communications device operable to receive respective configuration data for at least one of said avatars that determines their appearance, and operable to receive identification data identifying purchasable items visibly associated with a respective avatar;
a query device operable
to initiate a query of a first avatar in response to a user's avatar encountering the first avatar within the online virtual environment, the first avatar corresponding to a user of one of the remote entertainment devices and the user's avatar corresponding to a user of the entertainment device and
to identify to the user of the entertainment device purchasable items visibly associated with said first avatar;
wherein the data communications device is operable to transmit a purchase initiation request identifying an item for purchase, selected in response to a purchasable item visibly associated with said first avatar.

2. An entertainment device according to claim 1, in which said item for purchase is at least one item selected from the list consisting of:
a virtual item of clothing corresponding to an item of clothing worn by the queried avatar, for wear by the user's avatar;
a real item of clothing corresponding to an item of clothing worn by the queried avatar, for wear by the user;
a virtual accessory item corresponding to an accessory item visibly associated with the queried avatar, for association with the user's avatar; and
a real accessory item corresponding to an accessory item visibly associated with the queried avatar, for use by the user.

3. An entertainment device according to claim 1, in which an avatar represents said user of the entertainment device in the online virtual environment, and in which
said data communications device is operable to receive data signifying the purchase of an item to associate with said user's avatar, and
said display device is operable to generate for display said user's avatar modified in response to the purchased item associated with it.

4. An entertainment device according to claim 1, in which some or all of said identification data for said at least one avatar is distributed to the entertainment device as part of the avatar configuration data when said entertainment device connects to said online environment.

5. An entertainment device according to claim 1, in which some or all of said identification data for an avatar is distributed to said entertainment device in response to the initiation of a query of that avatar.

6. An entertainment device according to claim 1, in which said identification data comprises for each purchasable item at least one item selected from the list consisting of:
a respective ID code that is recognized by a server administering the online environment;
a respective ID code that is recognized by a sales server; and
a URL to an online store;

7. An entertainment device according to claim 1, in which
said display device is operable to generate for display as displayed information within a graphical interface at least one information selected from the list consisting of:
price;
availability;
available sizes;
available colors;
images of an item; and
logos or marks associated with an item,
as appropriate.

8. An entertainment device according to claim 7, in which the displayed information is responsive to the geographical location of said entertainment device.

9. An entertainment device according to claim 7, in which the displayed information is received from a server in response to at least one item selected from the list consisting of:
a query of the respective avatar; and
a purchase initiation request.

10. A server for administering an online virtual environment, the server comprising:
a data communications device
operable to transmit to an entertainment device connected to the online virtual environment configuration data that determines the appearance of at least one avatar associated with further entertainment devices connected to said online virtual environment, and
operable to transmit, in response to a user's avatar encountering a first avatar within the online environment, data identifying purchasable items visibly associated with the first avatar corresponding to a user of one of the further entertainment devices.

11. A server according to claim 10 in which said data communications device is further operable to receive from an entertainment device a purchase initiation request identifying an item for purchase related to a purchasable item as identified in said data transmitted to the entertainment device.

12. A server according to claim 11 comprising a processor operable to acquire payment from a user of the entertainment device, and authorize modification of the configuration data of the user's avatar to incorporate the purchased item.

13. A server according to claim 11 comprising a processor operable to acquire from a user of the entertainment device payment and personal details required for delivery of a real item, and to place an order with the appropriate supplier for the real item to be delivered to said user.

14. A method of online transaction, the method comprising the steps of:
connecting an entertainment device to an online virtual environment populated by at least one avatars representing other users of the online virtual environment;
receiving respective configuration data for said at least one avatar that determines their appearance;
identifying in response to a user's avatar encountering a first avatar within the online virtual environment, purchasable items visibly associated with first avatar, the first avatar corresponding to one of the other users of the online environment, and the user's avatar corresponding to a user of the entertainment device; and
transmitting to a server a purchase initiation request identifying an item for purchase selected in response to a purchasable item visibly associated with the first avatar.

15. A method of online transaction according to claim 14 in which said item for purchase is at least one item selected from the list consisting of:
a virtual item of clothing corresponding to an item of clothing worn by the first avatar, for wear by the user's avatar;
a real item of clothing corresponding to an item of clothing worn by the first avatar, for wear by the user;
a virtual accessory item corresponding to an accessory item visibly associated with the first avatar, for association with the user's avatar; and
a real accessory item corresponding to an accessory item visibly associated with the first avatar, for use by the user.

16. A method of online transaction according to claim 14 comprising the steps of:
determining that an item for association with a user's avatar has been successfully purchased, and
reconfiguring said user's avatar to incorporate the purchased item.

17. A method of online transaction according to claim 16 comprising the step of reconfiguring the first avatar to remove the purchased item.

18. A method of online transaction according to claim 14 comprising the steps of:
determining that a real item for delivery to a user has been successfully purchased, and placing an order with an appropriate supplier for the item to be delivered to the user.

19. A computer readable storage medium comprising:
a computer readable code for executing on a computer causing
a display device to generate for display a representation of an online virtual environment, and to generate for display within said representation of the online virtual environment at least one avatar corresponding to users of at least one remote entertainment device interacting with the online virtual environment;
a data communications device to receive respective configuration data for at least one of said avatars that determines their appearance, and operable to receive identification data identifying purchasable items visibly associated with a respective avatar;
a query device
to initiate a query of a first avatar in response to a user's avatar encountering the first avatar with the online virtual environment, the first avatar corresponding to a user of one of the remote entertainment devices and the user's avatar corresponding to a user of the entertainment device, and
to identify to the user of the entertainment device purchasable items visibly associated with said first avatar;
the data communications device transmitting a purchase initiation request identifying an item for purchase, selected in response to a purchasable item visibly associated with said first avatar.

20. A computer readable storage medium comprising:
a computer readable code for executing on a computer causing
a data communications device
to transmit to an entertainment device connected to the online virtual environment configuration data that determines the appearance of at least one avatar associated with further entertainment devices connected to said online virtual environment, and
to transmit, in response to a user's avatar encountering a first avatar within the online environment, data identifying purchasable items visibly associated with the first avatar corresponding to a user of one of the further entertainment devices.

21. A computer readable storage medium comprising:
a computer readable code for executing on a computer wherein the computer
connects an entertainment device to an online virtual environment populated by at least one avatars representing other users of the online virtual environment;
receives respective configuration data for said at least one avatar that determines their appearance;
identifies, in response to a user's avatar encountering a first avatar within the online virtual environment, purchasable items visibly associated with first avatar, the first avatar corresponding to one of the other users of the online environment, and the user's avatar corresponding to a user of the entertainment device; and
transmits to a server a purchase initiation request identifying an item for purchase selected in response to a purchasable item visibly associated with the first avatar.
